(19) United States
(12) Patent Application Publication
(10) Pub. No.: US 2008/0092207 A1
(43) Pub. Date: Apr. 17, 2008

(54) System Integration Method Based on System Entity Structure

(76) Inventors: Hyung-Jong Kim, Seoul (KR); Jun Yoon, Yongin-si (KR); Won Tae Sim, Sungnam-si (KR); Woo-Han Kim, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(21) Appl. No.: 11/553,227

(22) Filed: Oct. 26, 2006

(30) Foreign Application Priority Data
Oct. 13, 2006 (KR) 10-2006-0099680

(51) Int. Cl. H04L 9/32

(52) U.S. Cl. 726/2

(57) ABSTRACT

Disclosed is a system integration method based on a system entity structure (SES). The method comprises steps of (a) analyzing an integration target system to extract a technology attribute and to represent the integration target system as a system entity structure (SES); and (b) carrying out a pruning operation for constitution elements of the integration target system represented as the system entity structure (SES) in the step (a), in consideration of the technology attribute extracted in the step (a), an environmental factor and a pruning rule, which being a basis for selection of constitutional technological elements. The invention is particularly effective for an integration target system having various element technologies such as information security system.

### CROSS-REFERENCE TO RELATED APPLICATIONS

This application claims all benefits of Korean Patent Application No. 10-2006-99680 filed on Oct. 13, 2006 in the Korean Intellectual Property Office, the disclosures of which are incorporated herein by reference.

### BACKGROUND OF THE INVENTION

1. Field of the Invention

The present invention relates to a system integration method based on a system entity structure.

2. Description of the Prior Art

A system entity structure (SES) is a technique for representing a system as an entity structure, and specifically, dividing technical elements constituting the system into decomposition and specialization relations to represent it hierarchically.

FIG. 1 shows an example of a system entity structure.

In FIG. 1, a A node has a A-dec relation with a B node and a C node which are child nodes. The term “dec” of the A-dec is an abbreviation of decomposition. The relation between the A node and the B and C nodes means that the A node can be expressed by a combination of the B and C nodes and also means that the A node can be decomposed into the B and C nodes. In the dec relation, connection relations between the respective nodes are important to describe a system. FIG. 1 shows the connection relations as a set pattern with respect to each dec relation. For example, in the expressions such as {(A.in, B.in), (A.in, C.in), (B.out, A.out), (C.out, A.out)}, an input of the A node is transferred to the B and C nodes at the same time and outputs of the B and C nodes come from the A node.

In FIG. 1, the B node has a B-spec relation with a B1 node and a B2 node. The term “spec” of the B-spec is an abbreviation of specialization. The relation between the B node and the B1 and B2 nodes means that the B node is specialized into one of the B1 and B2 nodes. In other words, specialization means that only one of the corresponding child nodes will be selected. Regarding the selection, there should be a rule. The dotted line in FIG. 1 shows one rule for the selection. This means that if it is selected that the B node is specialized into the B1 node, a D node and a G node should select a D1 node and a G1 node, respectively.

The concept of the system entity structure (SES) enables all structures, which can be provided to a specific structure, to be represented and a system structure specification suitable for an environment can be derived from such system entity structure (SES).

FIG. 2 shows a system structure for an elevator in a building as a system entity structure (SES). In the mean time, in the SES shown in FIG. 2, a rule for specialization is not shown as a dotted line. The rule can be expressed by a dotted line in a system entity structure (SES) as shown in FIG. 1. Alternatively, the rule can be directly indicated in the SES as shown in FIG. 2 below, instead of using the dotted line.

```
Rule 1 - if select freight from carriage spec
  then select lift from motion spec
    and select cargo from contents spec
Rule 2 - if select passenger from carriage spec
  then select people from contents spec
```

### SUMMARY OF THE INVENTION

The invention intends to integrate systems using the method of representing the system entity structure (SES) described above. Specifically, an object of the invention is to use a system entity structure (SES) to hierarchically represent a structure of each system and to carry out a pruning operation so as to select constitutional elements of a specific system, thereby integrating the systems.

### BRIEF DESCRIPTION OF THE DRAWINGS

The above and other objects, features and advantages of the present invention will be more apparent from the following detailed description taken in conjunction with the accompanying drawings, in which:

FIG. 1 shows an example of a system entity structure;

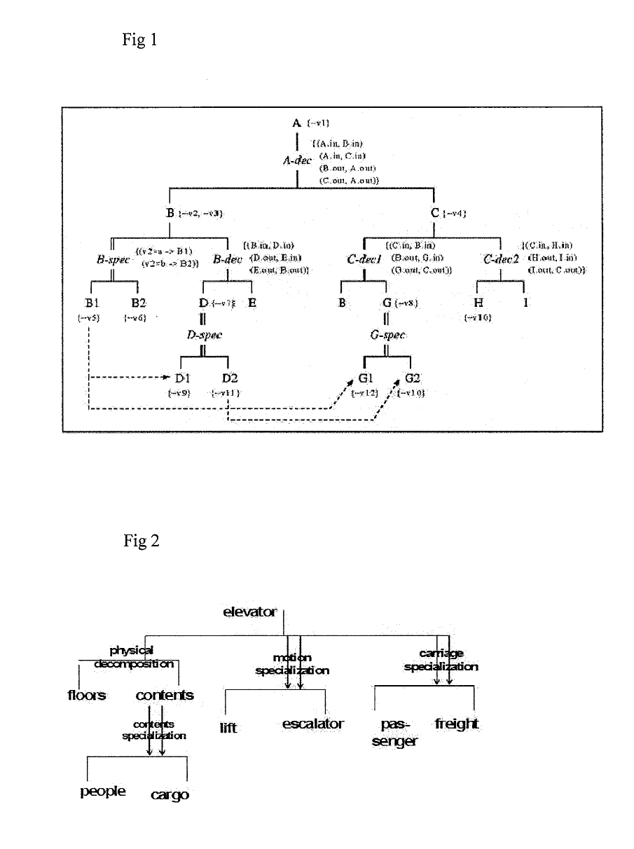

FIG. 2 shows a system structure for an elevator in a building as a system entity structure (SES);

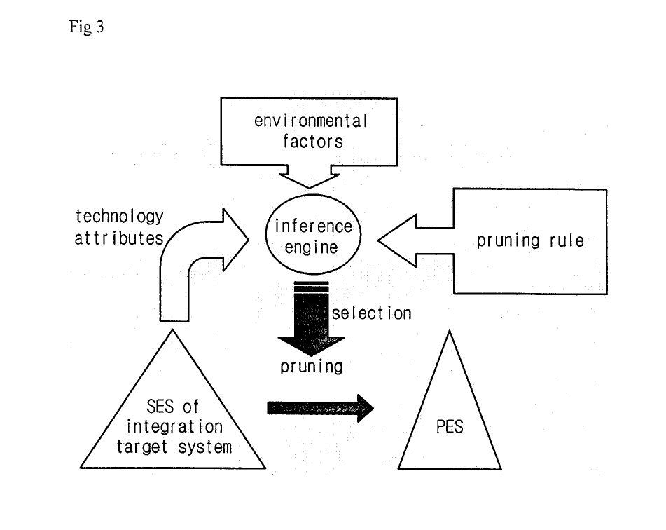

FIG. 3 is a conceptual view showing a system integration method based on a system entity structure (SES);

FIG. 4 shows a table in which constitutional elements are classified on the basis of three considerations;

FIG. 5 shows whether the major, middle and minor classes shown in FIG. 4 have a specialization relation or a decomposition relation with each other; and

FIG. 6 shows the environmental factors considering the application target, the applied technology and the performance.

### DETAILED DESCRIPTION OF THE PREFERRED EMBODIMENTS

Hereinafter, a preferred embodiment of a system integration method based on a system entity structure according to the present invention will be described with reference to the accompanying drawings.

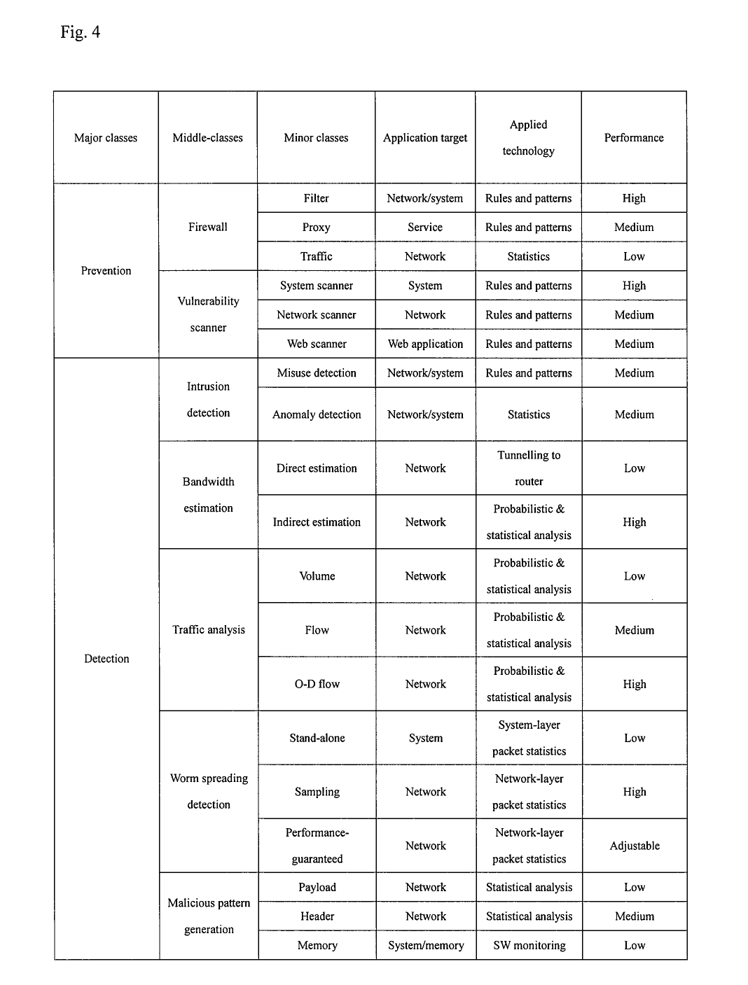

FIG. 3 is a conceptual view showing a system integration method based on a system entity structure (SES).

As shown in FIG. 3, an integration target system is analyzed to extract a technology attribute and to represent the system as a system entity structure (SES). It carries out a selection operation for constitutional elements of the integration target system in an inference engine in consideration of the technology attribute, an environmental factor and a pruning rule. Such selection operation is referred to as a pruning operation. A system entity structure (SES), which consists of the constitutional elements selected through the pruning operation, is referred to as a pruned entity structure (PES). The PES is a system entity structure (SES) of an integrated system and has a specification of the integration system.

In the following, a system integration method based on a system entity structure according to the invention is described in detail with reference to an information protection system.

In representing an information protection system as a system entity structure (SES), the ‘technology attribute’ means an attribute of an information protection technology which will become each node of the SES. In order to deduce the technology attribute, it is required a classification operation for each element technology for the integration target system. This is referred to as technology taxonomy.

In the technology taxonomy, with regard to major classes, each constitution technology is classified into Prevention, Detection and Response for an attack on the basis of applied point of time for the technology.

First, the Prevention is a technology for preventing an attack in advance. Some examples of the main technologies associated with the Prevention are as follows.

Firewall: it is a basis technology for access control and is set in consideration of characteristics of services and attacks. It comprises a form of filtering only with a port and IP information in accordance with an exterior request, a form of relaying a service in a proxy pattern and a form of filtering in consideration of statistics of traffics.

Vulnerability scanner: It is a technology for diagnosing and detecting vulnerability. Universal rules for inspecting the vulnerability are managed in a knowledge form and each rule for detecting vulnerability also has a category, so that the rules to be used are determined in accordance with the policies. The category for each vulnerability detection target includes a system scanner, a network scanner or web scanner.

Second, the Detection is a technology for detecting an attack, based on a change of the system occurring after the attack or an attack input. It determines whether the attack succeeds, in accordance with a determination for the information provided due to the attack and the change of the system after the attack. The main technologies associated with the detection includes the following.

Intrusion Detection Tool
Misuse detection—it stores attack patterns and detects whether there occurs an attack on the basis of such patterns.
Anomaly detection—based on the statistics information on the ordinary acts, it detects an act in violation of it.

Bandwidth Estimation Tool
directly estimating a bandwidth on a real time basis through a network equipment
estimating a network bandwidth through an indirect detection technology

Traffic Analysis Tool
volume data based analysis flow data based analysis
analysis through an O-D flow analysis

Worm Spreading Detection Tool
stand-alone system I/O pattern generation statistical sampling based analysis performance-guaranteed analysis

Malicious Code Pattern Generation Tool
payload based analysis
header information based analysis
memory contents based pattern generation

Third, when the attack or damage is detected, the Response defines and carries out a main method of coping with it. The main technologies associated with the Response are as follows:

Alarm or Inform
alarm through a user interface
inform through an e-mail or personal portable equipment
Reaction or backup
attack-related surface block (port block or IP block)
attack pattern based block (payload and statistical information based block)
backup for recovering data and system

In order to deduce an associated relation between the respective technologies after the technology taxonomy, the attributes of the respective technologies are further classified in consideration of “technology application target,” “technology applied for protection” and “performance characteristic of technology.” The three considerations have the following meanings.

Technology Application Target
types of attack or vulnerability to be defended through a technology
targets (network, service or system) to be protected through a technology

Technology Applied for Protection
characteristics of a specific mechanism using the technology such as statistical technology, knowledge based technology, data mining technology

Performance Characteristic of Technology
even though the technologies can be used in same target, they may have different performance characteristics. The characteristics can be expressed in a qualitative index such as High, Medium, Low or Adjustable.

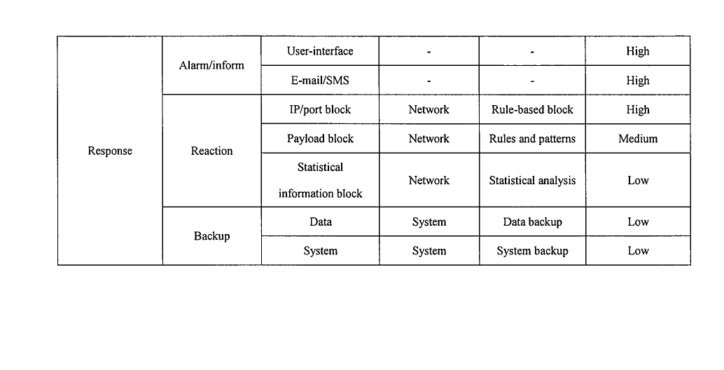

The constitution elements classified on the basis of the three considerations are shown in FIG. 4.

In the mean time, the relation between the major class and the middle class is determined as specialization or decomposition relation on a system entity structure (SES), as shown in FIG. 4. The relation between the middle class and the minor class is defined in the same way. For example, in case of the technologies for achieving the same object, they are set as a specialization relation. In case that the lower technologies should become the constitutional elements so as to complete the corresponding technology, the corresponding technology and the lower technologies are set as a decomposition relation.

In the following, an example of the relation of the element technologies for an information protection system is described.

<prevention Technology>

A Relation of the Major and Middle Classes
the firewall and the vulnerability scanner constituting the prevention technology are set as a decomposition relation.

A Relation of the Middle and Minor Classes
the firewall and the three lower detailed technologies are set as a decomposition relation.
the vulnerability scanner and the three lower detailed technologies are set as a specialization relation.

<Detection Technology>
a relation of the major and middle classes
although there exists an area in which some of the detection technologies overlap, all relations are set as a decomposition because the respective technologies may exist independently in consideration of the object of the system integration.

a Relation of the Middle and Minor Classes
the intrusion detection technology and the two lower detailed technologies are set as a specialization relation.
the bandwidth estimation technology and the two lower detailed technologies are also set as a specialization relation.
the traffic analysis technology and the three lower detailed technologies are also set as a specialization relation.
the worm spreading detection technology and the three lower detailed technologies are also set as a specialization relation.
the malicious pattern generation technology and the three lower detailed technologies are also set as a specialization relation.

<Recovery Technology>
a relation of the major and middle classes
the alarm and inform, the response and the backup are set to be in a decomposition relation with each other.

A Relation of the Middle and Minor Classes
the alarm and inform and the two lower detailed technologies are set as a specialization relation.
the response and the three lower detailed technologies are also set as a specialization relation.
the backup and the two lower detailed technologies are also set as a specialization relation.

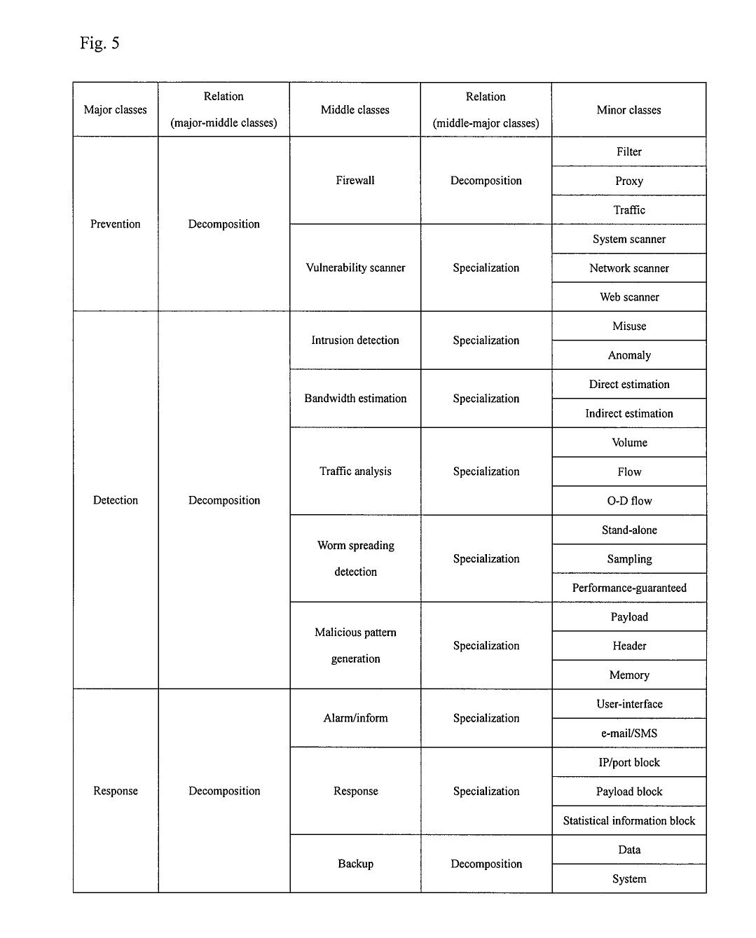

FIG. 5 shows associated relations among the major, middle and minor classes shown in FIG. 4. The relations can be represented as a specialization or a decomposition relation.

As an embodiment of the invention, the information security technologies have been analyzed to extract the technology attributes and to represent the system entity structure (SES) for showing the way of integration of information security system for a specific network environment.

In the following, environmental factors which are considered in the pruning operation with regard to the information security system are described.

In the environmental factor, the three elements which have been clearly stated in the technology attributes, i.e., the application target, the applied technology and the performance will be considered. Specifically, the three elements become a basis for deciding what technology will be used in the specialization.

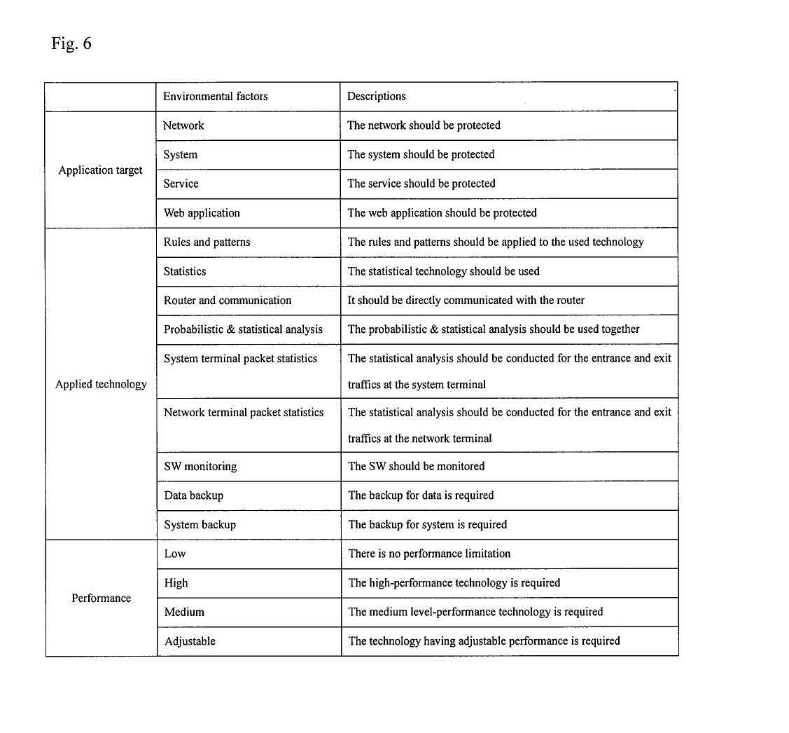

FIG. 6 shows the environmental factors considering the application target, the applied technology and the performance.

For example, in application target point of view, the environmental factors are related with where a technology will be applied, such as a network, system or service.

The way of setting the environmental factors may vary depending on the system to which the invention is applied.

Finally, described below is a pruning rule which is considered for the pruning operation in the information protection system according to an embodiment of the invention.

In the pruning step of the invention, the constitutional elements of the system are selected in consideration of the technology attributes and the environmental factors, thereby making a pruned entity structure (PES). At this time, there is required a rule for selecting the constitutional elements. The pruning rule selects a necessary technology, based on the application target, the applied technology and the performance which the environmental factors show.

In the following, examples of the pruning rule will be shown. From the sets, it is possible to see how each of the rule sets is inferred on the basis of the application target, the applied technology and the performance.

<Example 1 of the Pruning Rule Set
object: pruning for selecting the vulnerability scanner
If major classes=prevention and middle classes=vulnerability scanner
Then selecting the vulnerability scanner:=True
If selecting the vulnerability scanner=True and application target=network
Then network vulnerability scanner:=True
If selecting the vulnerability scanner=True and application target=system
Then system vulnerability scanner:=True
If selecting the vulnerability scanner=True and application target=web application
Then web vulnerability scanner:=True
Through the inference using the pruning rule in the example 1, the appropriate vulnerability scanner can be selected among the vulnerability scanners.

<Example 2 of the Pruning Rule Set>
object: pruning for selecting the worm spreading detection tool
If major classes=detection and middle classes=worm spreading detection
Then selecting the worm spreading detection tool:=True
If selecting the worm spreading detection tool=True and performance=High
Then selecting the sampling worm spreading detection tool:=True
If selecting the worm spreading detection tool=True and performance Low
Then selecting the stand-alone worm spreading detection tool:=True
If selecting the worm spreading detection tool=True and performance=Adjustable
Then performance-guaranteed work spreading detection tool:=True

Through the inference using the pruning rule in the example 2, the detection tool of the minor classes is selected among the worm spreading detection tools

The PES consisting of the constitution elements selected as described above is a specialized system entity structure of the integration system and has a specification suitable for the object of the integration system among the various element technologies.

As described above, the invention relates to a system integration method based on a system entity structure (SES), and specifically, uses the system entity structure (SES) to hierarchically represent the structure of each system and carries out a pruning operation so as to select a structure of a specific system, thereby integrally structuring a system. Through making use of the invention, a necessary system can be structured by the selection, so it is particularly effective for an integration target system having various element technologies such as information security system.

While the invention has been shown and described with reference to certain preferred embodiments thereof, it will be understood by those skilled in the art that various changes in form and details may be made thereto without departing from the spirit and scope of the invention as defined by the appended claims.

What is claimed is:

1. A system integration method based on a system entity structure, the method comprising steps of:
(a) analyzing an integration target system to extract a technology attribute and to express the integration target system as a system entity structure (SES); and
(b) carrying out a pruning operation for constitution elements of the integration target system represented as the system entity structure (SES) in the step (a), in consideration of the technology attribute extracted in the step (a), an environmental factor and a pruning rule, which being a basis for selection of constitutional technological elements.

2. The method according to claim 1, wherein the step (a) comprises steps of:
hierarchically classifying element technologies of the integration target system; and
classifying associated relations of the technologies classified in the step into a decomposition or specialization relation of the system entity structure (SES).

3. The method according to claim 2, wherein in the step of hierarchically classifying element technologies of the integration target system in the step (a), each element technology is classified on the basis of applied the point of time for the technology.

4. The method according to claim 2, wherein the associated relations of the respective element technologies in the step (a) are based on application target of the technology, applied technology and performance of the technology.

5. The method according to claim 4, wherein the environmental factor in the step (b) is also based on application target of the technology, applied technology and performance of the technology.

6. The method according to claim 5, wherein when the integration target system is an information security system, in the step of hierarchically classifying element technologies of the integration target system in the step (a), each element technology is classified into ‘Prevention,’ ‘Detection’ and ‘Response.’

7. The method according to claim 6, wherein the element technology classified as the ‘Prevention’ in the step (a) comprises a firewall or vulnerability detection tool.

8. The method according to claim 6, wherein the element technology classified as the ‘Detection’ in the step (a) comprises one or more of an intrusion detection tool, a bandwidth estimation tool, a traffic analysis tool, a worm spreading detection tool and a malicious code pattern generation tool.

9. The method according to claim 6, wherein the element technology classified as the ‘Response’ in the step (a) comprises one or more of an alarm or inform technology, a block and a backup.
